(19) United States
(12) Patent Application Publication
(10) Pub. No.: US 2011/0011287 A1
(43) Pub. Date: Jan. 20, 2011

(54) Media Embellishing System and Method

(76) Inventor: Ellen Hutson, Issaquah, WA (US)

Correspondence Address: GRAYBEAL JACKSON LLP, 400 - 108TH AVENUE NE, SUITE 700, BELLEVUE, WA, 98004, US

(21) Appl. No.: 12/505,371

(22) Filed: Jul. 17, 2009

(51) Int. Cl. B41F 19/02

(52) U.S. Cl. 101/26

(57) ABSTRACT

Systems and methods are provided herein that provide for media embellishment.

### FIELD

This invention relates generally to media, and more specifically, to systems and methods for media embellishing.

### BACKGROUND

The scrapbooking and paper craft industry has become increasingly popular in recent years. It is estimated that a quarter of United States households participate in scrapbooking. As a result, scrapbooking has become an industry exceeding $1.5 billion in annual sales.

Of those households that participate in scrapbooking, it is estimated that nine percent of such households have a person who spends two or more hours a week on scrapbooking projects. Consequently, many different tools have been created to assist scrapbookers in pursuing this hobby.

Many of the instruments used in scrapbooking are designed to provide quick, precise and repeatable die cutting, imprinting and embossing of a pattern onto a flat media such as a paper substrate. There are various crafting die cutters, imprinters and embossers on the market, some of which are referred to as corner dies or edge dies.

Corner dies and edge dies have similar features; for example, most are hand-held punches that punch relatively to the edge of the paper, with the exception of a few long reach punches which punch as deep as 3¼″ from the edge into the paper. Additionally, because such dies perform only a single function, users must collect many tools to achieve variety in their works, which makes their use non-economical.

Other die cutting and embossing devices employ the use of dies and a press for firmly pressing the die against a sheet to cut or emboss the sheet into a desired shape. Such die presses may comprise a pair of rollers or flat pressing surfaces and are typically hand operated. The dies associated with such systems are also deficient because each die fails to provide users with sufficient design variety and therefore the user must purchase a multitude of dies to achieve desired artistic variety.

A further system for cutting shapes in sheet materials is an electronic cutter. Various electronic cutters, for example, are configured to cut a shape or series of shapes in a sheet of adhesive backed vinyl that can be peeled from the sheet and applied to another material, such as a banner, for forming a relatively inexpensive sign. These electronic cutters are relatively expensive and require connection to a computer and computer software to drive the electronic cutter.

### BRIEF DESCRIPTION OF THE DRAWINGS

The present invention will be described by way of exemplary embodiments but not limitations, illustrated in the accompanying drawings in which like references denote similar elements, and in which:

FIG. 1a is a top view of a media embellishing die, in accordance with various embodiments.

FIG. 1b is a bottom view of a media embellishing die, in accordance with various embodiments.

FIG. 2 depicts a media embellishing die, a piece of planar media, and a first and second compression plate in accordance with various embodiments.

FIG. 3 is a depiction of embellished planar media in accordance with an embodiment.

FIG. 4 depicts a media embellishing die, a piece of planar media, an embossing mat, and a first and second compression plate in accordance with various embodiments.

FIG. 5 is a depiction of embellished planar media in accordance with an embodiment.

FIG. 6 depicts a media embellishing die, a piece of planar media, an embossing mat, and a first and second compression plate in accordance with various embodiments.

FIG. 7 is a depiction of embellished planar media in accordance with an embodiment.

FIG. 8a is a depiction of embellished planar media in accordance with another embodiment.

FIG. 8b is a depiction of embellished planar media in accordance with a further embodiment.

FIG. 9 is a block diagram of a media embellishing routine in accordance with an embodiment.

FIG. 10 is a depiction of a media embellishing die and an embellishing guide in accordance with an embodiment.

FIG. 11 is a block diagram of a media embellishing routine in accordance with an embodiment.

### DESCRIPTION

Illustrative embodiments presented herein include, but are not limited to, systems and methods for embellishing media

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

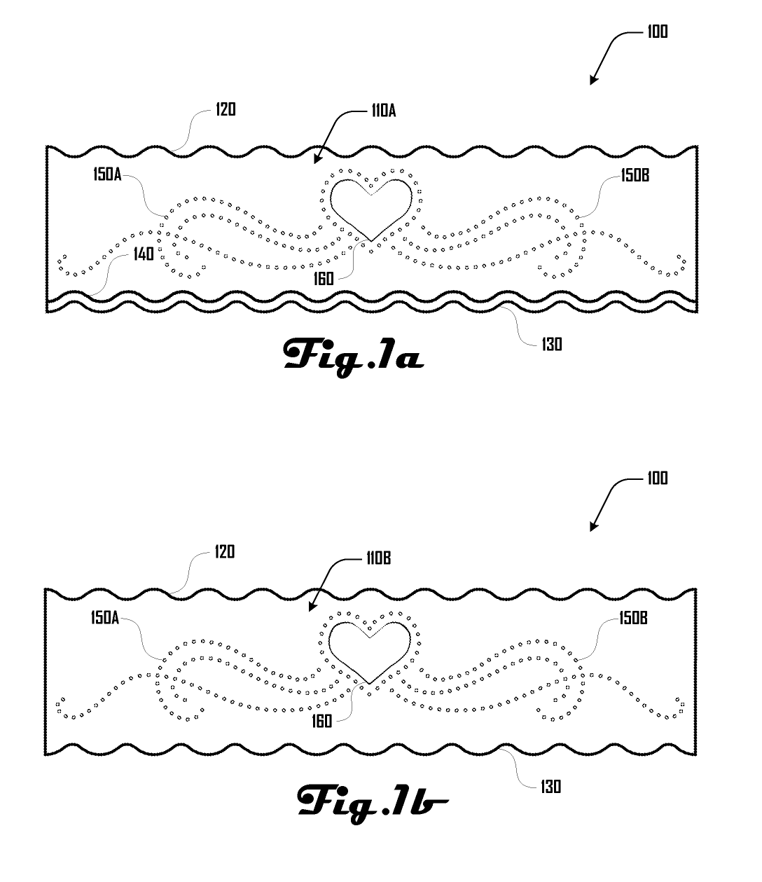

FIG. 1a is a top view of a first embellishing side 110A of a media embellishing die 100, in accordance with various embodiments, and FIG. 1b is a bottom view of a second embellishing side 110B of a media embellishing die 100, in accordance with various embodiments. In some embodiments, the media embellishing die 100 may be substantially planar and be made of various materials such as metal, plastic, and the like. In some embodiments, the media embellishing die 100 may be transparent or translucent.

In various embodiments, it may be desirable to have a transparent or translucent embellishing die 100 because a user may more readily be able to position the embellishing die 100 over media being embellished to align the embellishing die 100 with existing embellishments, patterns or features of the media. For example, an embellishing die 100 may be used to cut or emboss the edge of a piece of paper, and making a cut or embossing parallel to the edge of the paper may be easier to accomplish if the embellishing die 100 is transparent.

The media embellishing die 100 comprises a plurality of embellishing holes 150, which are defined by the media embellishing die 100 and extend therethrough. An exemplary first and second embellishing hole 150A, 150B are labeled in the in these and additional figures. In various embodiments, the embellishing holes 150 may be various sizes and of various configurations. In some embodiments, embellishing holes 150 may be of an appropriate size to facilitate piercing media or to accommodate a piercing tool.

As depicted in FIGS. 1a and 1b, the media embellishing die 100 further comprises an embellishing orifice 160, which is defined by the media embellishing die 100. The embellishing orifice 160 may be various sizes, shapes and in various embodiments there may be a plurality of embellishing orifices 160 in various configurations. Additionally, as discussed herein, the embellishing orifice 160 may be operable to emboss planar media 210 in various embodiments.

The media embellishing die 100 also comprises an embellishing ridge 140 on the first embellishing side 110A. In various embodiments, the embellishing ridge 140 may be a member that extends from the substantially planar surface of the media embellishing die 100. The embellishing ridge 140 may be various shapes, sizes, and in various configurations, and in some embodiments, there may be a plurality of embellishing ridges 140. In further embodiments, one or more embellishing ridge 140 may be present on either or both embellishing sides 110A, 110B of a media embellishing die 100. As shown in FIG. 1a, the embellishing ridge 140 may correspond to one or more embellishing edge 120, 130 and may be parallel thereto. Additionally, as discussed herein, the embellishing ridge 140 may be operable to cut and/or emboss planar media 210 in various embodiments.

The media embellishing die 100 further comprises a first and second embellishing edge 120, 130 on opposing edges of the media embellishing die 100. As shown here, the first and second embellishing edge 120, 130 are scalloped shaped, however, various other shapes and configurations of the first and second embellishing edge 120, 130 are contemplated in accordance with additional embodiments. In various embodiments, the first and second embellishing edge 120, 130 may be symmetrical to each other about one or more axis, may be parallel, and the like. Additionally, as discussed herein, the first and second embellishing edge 120, 130 may be operable to cut and/or emboss planar media 210 in various embodiments.

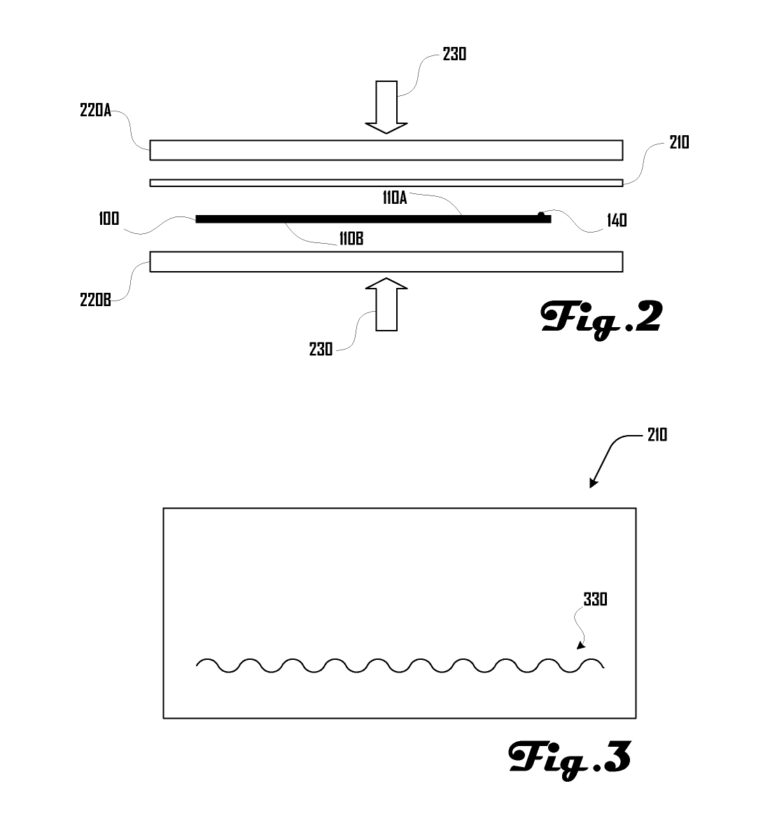

FIGS. 2, 4, and 6 depict various embodiments wherein a media embellishing die 100 is configured to cut and or emboss a piece of planar media 210. Depicted are a first and second compression plate 220A, 220B which transfer compression forces 230 to the planar media 210 and media embossing die 100 positioned therebetween. In some embodiments, embossing mat 440 may be present between the first and second compression plate 220A, 220B.

FIGS. 3, 5 and 7 depict embellished planar media 210, which has been embellished via a configuration depicted in FIGS. 2, 4, and 6 respectively. Cut and/or embossed planar media 210 is depicted in FIGS. 2, 4, and 6.

FIG. 2 depicts a media embellishing die 100, a piece of planar media 210, and a first and second compression plate 220A, 220B in accordance with various embodiments. As discussed herein, planar media 210 may be various types of substantially planar sheets, which may comprise materials such as paper, plastic, metal, a textile, and the like.

In various embodiments, the first and second compression plate 220A, 220B may be a ridged semi-ridged material such as wood, metal, plastic, and the like. In some embodiments the first and second compression plate 220A, 220B may be absent, one of the first and second compression plate 220A, 220B may be absent, or one or more of the first and second compression plate 220A, 220B may be replaced by elements or structures that perform a like function.

FIG. 2 depicts planar media 210 positioned facing the first embellishing side 110A of the media embellishing die 100, which comprises the embellishing ridge 140. When compression forces 230 are introduced, and the media embellishing die 100 and planar media 210 are compressed together, the embellishing ridge 140 may cut the planar media 210 and thereby generate an embellishing ridge cut 330. The embellishing ridge cut 330 may be a slit in the planar media 210 in various embodiments.

FIG. 3 is a depiction of exemplary embellished planar media 210 in accordance with such an embodiment; however, a ridge cut 330 may exist in various configurations. For example, while FIG. 3 depicts a ridge cut 330 that does not extend to the edge of the planar media 210, in some embodiments a ridge cut 330 may extend to one or more edge of such planar media 210. The ridge cut 330 may cleave planar media 210 into one or more pieces, or the ridge cut 330 may define one or more slit that extents to an edge of the planar media 210

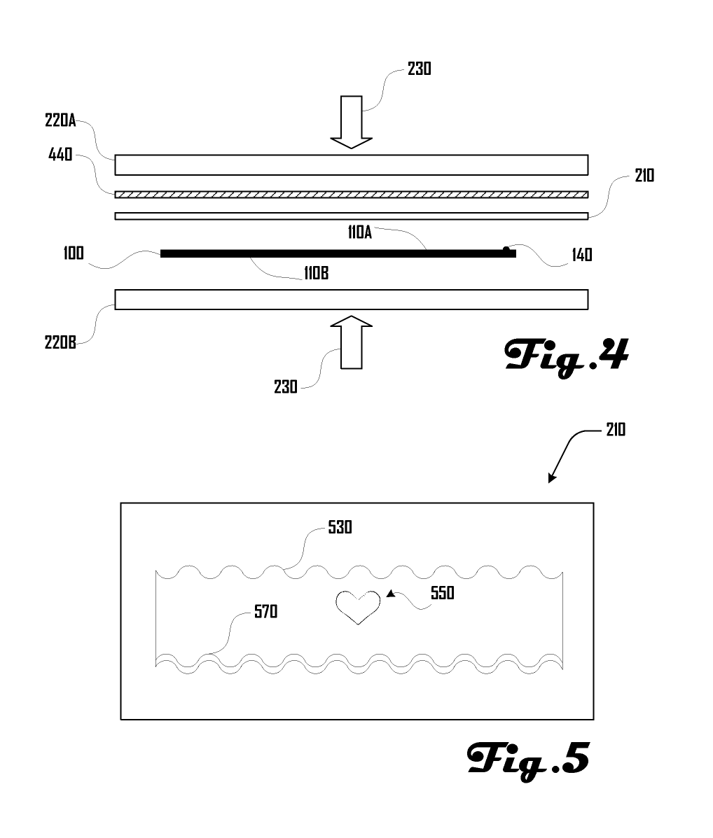

FIG. 4 depicts a media embellishing die 100, a piece of planar media 210, and an embossing mat 440 positioned between a first and second compression plate 220A, 220B in accordance with various embodiments. The first embellishing side 110A of the media embellishing die 100 is depicted facing the planar media 210, and the embossing mat 440 is on the opposing side of the planar media 210. In various embodiments, the embossing mat 440 may be a pliable, malleable or flexible, material such as rubber. In various embodiments, an embossing mat 440 having such properties is desirable because it allows the embellishing ridge 140 to emboss media instead of cut it.

Additionally, in some embodiments, an embossing mat 440 may also facilitate other portions of a media embellishing die 100 to emboss media, which may include an embellishing edge 120, 130, an embellishing orifice 160, an embellishing hole 150, and the like.

Although FIG. 4 depicts an embossing mat 440 as being separate from the first and second compression plate 220A, 220B, in various embodiments, an embossing mat 440 may be coupled or otherwise attached to a first and second compression plate 220A, 220B, or various other structures. For example, in some embodiments, an embossing mat 440, or material having the characteristics of an embossing mat 440, may comprise a portion of an apparatus that applies force 230 to a embellishing die 100, planar media 210 and the like.

Returning to FIG. 4, compression forces 230 may be applied such that the planar media 210 is compressed between the embossing mat 440 and the media embellishing die 100 such that the planar media 210 is embossed. For example, FIG. 5 depicts planar media that has been embossed via the configuration in FIG. 4. As shown in FIG. 5, the planar media comprises a perimeter embossing 530, an embellishing ridge embossing 570 and an embellishing orifice embossing 550.

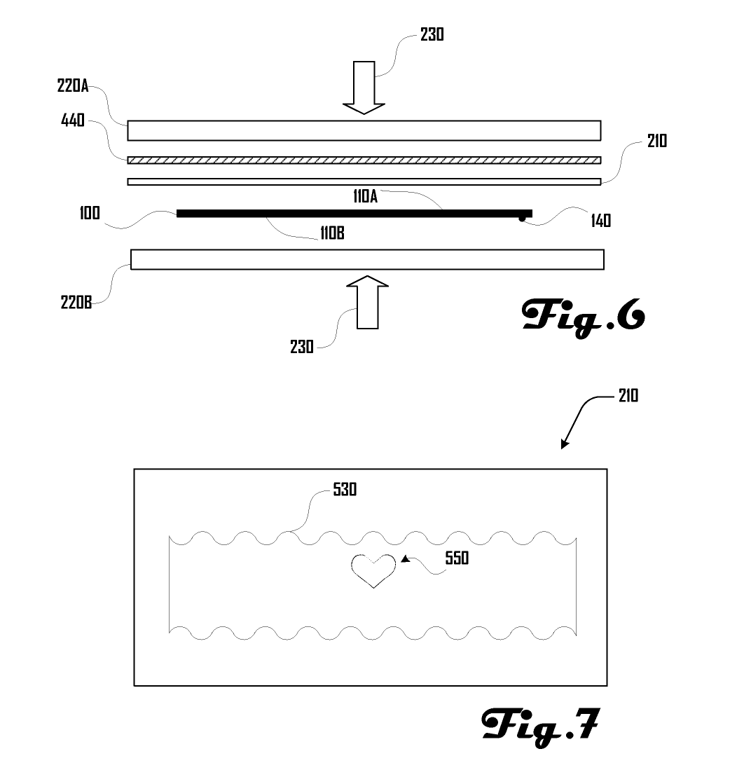

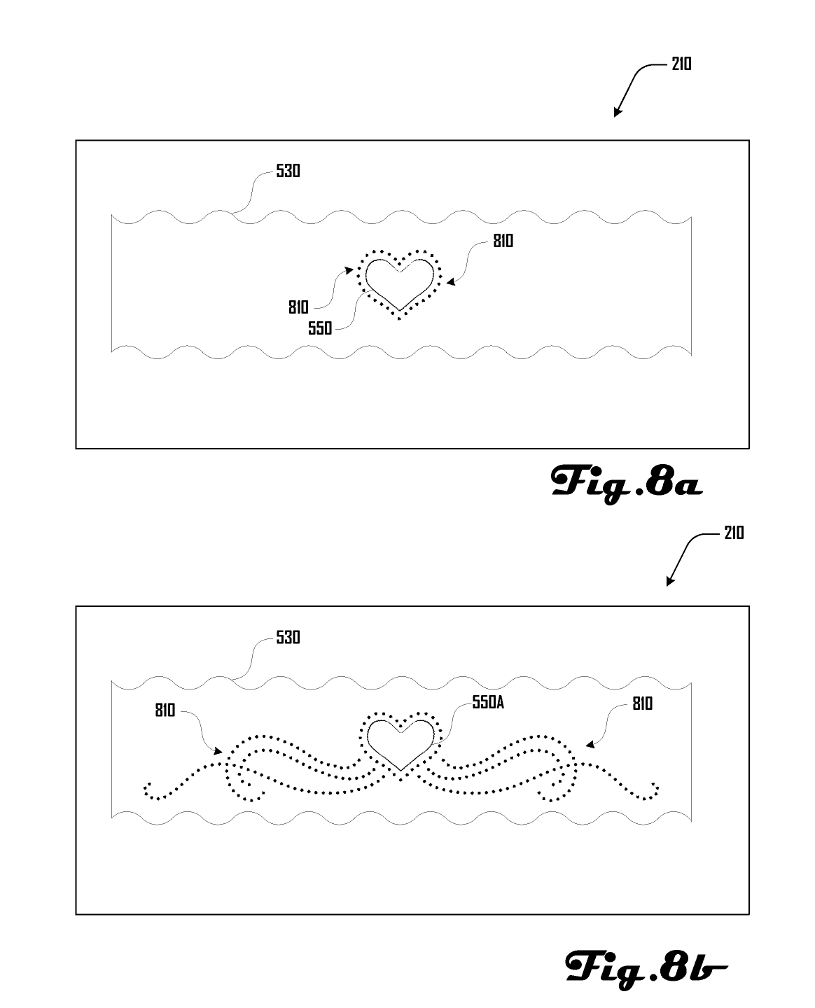

Similarly, FIG. 6 depicts a configuration of a media embellishing die 100, a piece of planar media 210 and an embossing mat 440, between a first and second compression plate 220A, 220B; however, in this embodiment, the media embellishing die 100 is oriented such that the embellishing ridge 140 is facing away from the planar media 210. Accordingly, the second embellishing side 110B of the embellishing media die 100 is facing the planar media 210.

Therefore, when compression forces 230 are applied, the planar media 210 is embossed as depicted in FIG. 7, wherein a perimeter embossing 530 and embellishing orifice embossing 550 are formed, but an embellishing ridge embossing 570 is not formed.

In some embodiments, one or more embellishing hole 150 may emboss planar media 210 when such planar media 210 is compressed as shown in FIGS. 2, 4, and/or 6. Additionally, compression of planar media 210 or introduction of compression forces 230 may be achieve through various methods and systems, which may include a press, hammering, hand compression. In various embodiments, a roller press may be used. For example, such presses may include the Ellison Big Shot (Ellison, Inc., Lake Forest, Calif.), Cuttlebug (Provo Craft & Novelty Inc., Spanish Fork, Utah), QuickKuts (QuickKutz, Inc. Lindon, Utah), and the like.

Additionally, in various embodiments, additional sheets, mats, or plates may be present to facilitate embossing or cutting of planar media 210. For example, a magnetic plate may be used to stabilize or hold planar media 210 between a media embellishing die 100 and the magnetic plate. Additionally, in various embodiments, planar media 210, and other media may be cut or embossed. Such media may include, paper, cardboard, plastic, fabric, metal, foil, and the like.

FIGS. 8a and 8b depict planar media that has been embossed and pierced in accordance with various embodiments. For example, the planar media depicted in FIGS. 8a and 8b may have been embossed as shown and described in FIGS. 6 and 7 and include embellishing orifice embossing 550 and a perimeter embossing 530. A media embellishing die 100 may then be placed on the embossed planar media 210 the plurality of embellishing holes 150 may be used as a template or guide to pierce the planar media.

For example, a piercing tool such as a pin or the like may be extended through one or more embellishing hole 150 and then pierce the planar media 210 such that a plurality of piercings 810 are formed. In an embodiment, where a media embellishing die 100 as shown in FIGS. 1a and 1b is used, some or all of the embellishing holes 150 may be selected to form piercings 810. Such variable selections are depicted in FIGS. 8a and 8b.

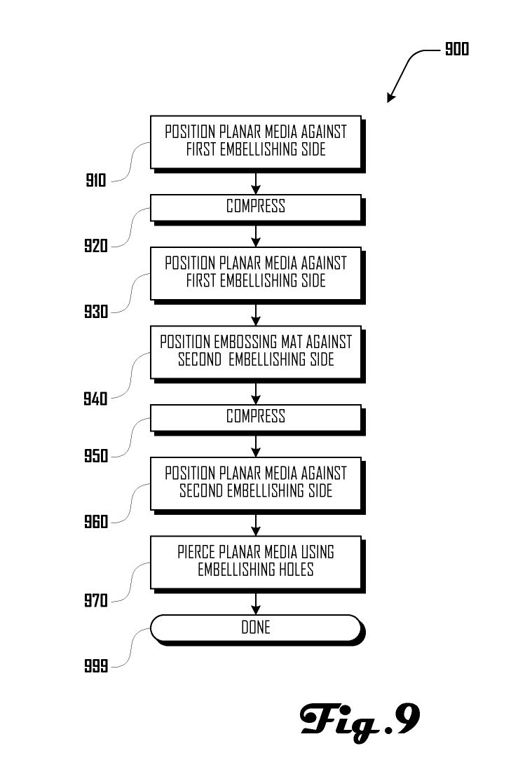

FIG. 9 is a block diagram of a media embellishing routine 900 in accordance with an embodiment. The media embellishing routine 900 begins in block 910 where planar media 210 is positioned against the first embellishing side 110A of a media embellishing die 100. The planar media 210 and media embellishing die 100 are compressed in block 920. In various embodiments, an embellishing ridge cut 330 may thereby be formed.

In block 930 the planar media 210 is positioned against the first embellishing side 110A of the media embellishing die 100, and in block 940 an embossing mat 440 may be positioned against the second embellishing side 110B of the media embellishing die 100.

The planar media 210, embossing mat 440 and media embellishing die 100 are compressed in block 950. In various embodiments, a perimeter embossing 530, an embellishing orifice embossing 550 and an embellishing ridge embossing 570 may thereby be formed.

In block 960 the planar media 210 may be positioned against the second embellishing side 110B of the media embellishing die 100 and in block 970 the planar media may be pierced using the embellishing holes 150 in the media embellishing die 100 as a template or guide for a piercing tool. The media embellishing routine 900 ends in block 999.

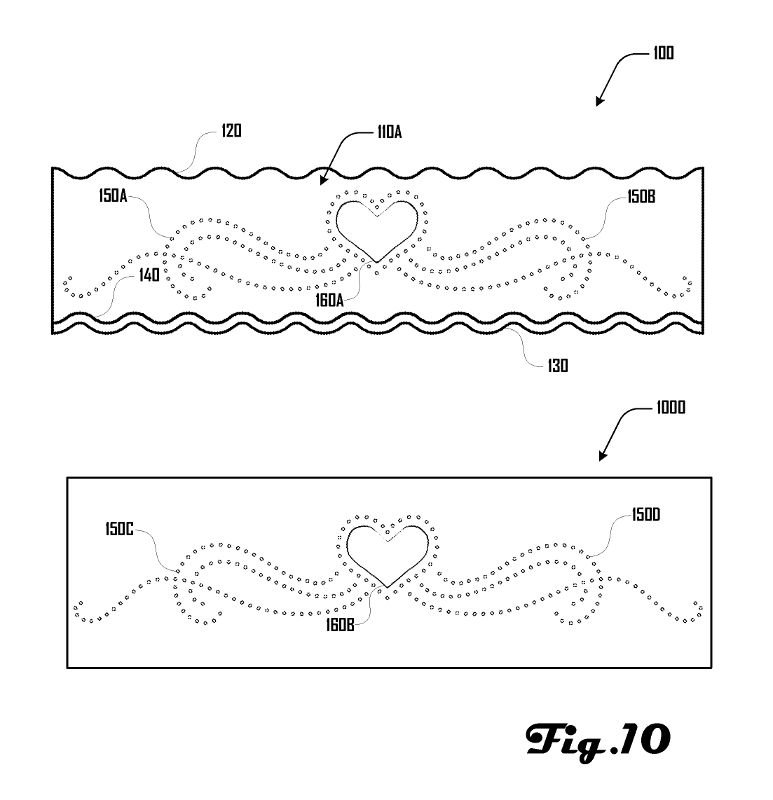

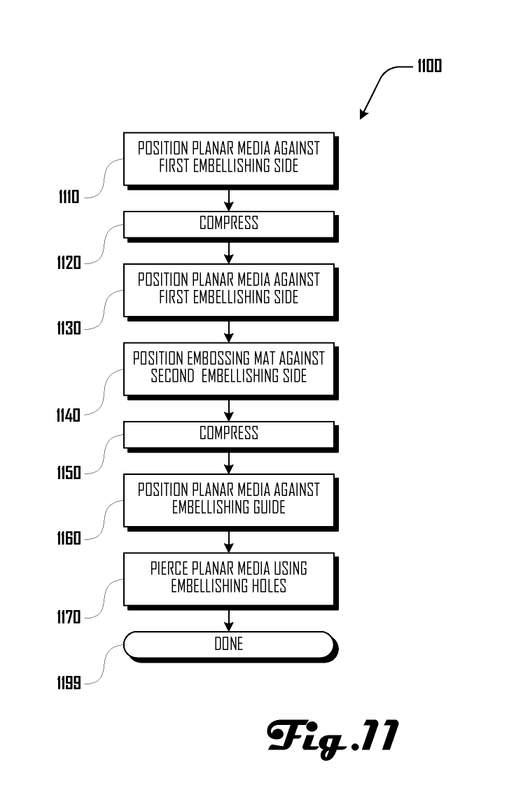

FIG. 10 is a depiction of a media embellishing die 100 and an embellishing guide 1000 in accordance with an embodiment. As described herein, the media embellishing die 100 may comprise a plurality of embellishing holes 150A, 150B an embellishing orifice 160A, an embellishing ridge 140 embellishing edges 120, 130, and the like.

Additionally, in various embodiments, there may be an embellishing guide 1000, which comprises one or more element, structure, or marking that is complementary to one or more element, structure, or marking of the embellishing die 100. As shown in FIG. 10, the embellishing guide 1000 may comprise complementary embellishing holes 150C, 150D and a complementary embellishing orifice 160B.

In some embodiments, for example, a plurality of embellishing holes 150 on an embellishing guide 1000 may correspond to embellishing holes 150 on an embellishing die 100, when the embellishing die 100 and corresponding embellishing guide 1000 are operable to be placed on top of one another and some or all of the plurality of embellishing holes 150 on the embellishing die 100 and corresponding embellishing guide 1000 can be aligned. Corresponding elements, structures, or markings may be the same size, approximately the same size, and the like.

In various embodiments, the embellishing guide 1000 may comprise other elements, structures or markings that correspond to various structures, elements or markings on an embellishing die 100. For example, there may be markings on the embellishing guide 1000 which correspond to the embellishing ridge 140 or to an embellishing edge 120, 140. In further embodiments, a complementary embellishing orifice 160B may be absent and a marking corresponding to the embellishing orifice 160A of an embellishing die 100 may be present.

In some embodiments, it may be desirable for the embellishing guide 1000 to be transparent or translucent because this may allow a user to more accurately align the embellishing guide 1000 over planar media 210 being embellished. Accordingly, the embellishing guide 1000 may comprise various materials such as a plastic or a polymer. In some embodiments, the transparent or translucent embellishing guide 1000 may be tinted or comprise a color tint. As used herein, the term ‘light transmissive’ encompasses the terms ‘transparent’ and ‘translucent.’

FIG. 11 is a block diagram of a media embellishing routine in accordance with an embodiment. The media embellishing routine 1100 begins in block 1110 where planar media 210 is positioned against the first embellishing side 110A of a media embellishing die 100. The planar media 210 and media embellishing die 100 are compressed in block 1120. In various embodiments, an embellishing ridge cut 330 may thereby be formed.

In block 1130 the planar media 210 is positioned against the first embellishing side 110A of the media embellishing die 100, and in block 1140 an embossing mat 440 may be positioned against the second embellishing side 110B of the media embellishing die 100.

The planar media 210, embossing mat 440 and media embellishing die 100 are compressed in block 1150. In various embodiments, a perimeter embossing 530, an embellishing orifice embossing 550 and an embellishing ridge embossing 570 may thereby be formed.

In block 1160 the planar media 210 may be positioned against an embellishing guide 1000 and in block 1170 the planar media may be pierced using embellishing holes 150 in the embellishing guide 1000 as a template or guide for a piercing tool. The media embellishing routine 1100 ends in block 1199. In some embodiments, the embellishing guide 1000 may be used as a template or guide for drawing or otherwise marking planar media 210.

Although the media embellishing routine 900 depicted in FIG. 9 and media embellishing routine 1100 depicted in FIG. 11 depict various steps occurring in a certain order. These steps may be performed in various suitable orders and may be performed one or more times in accordance with various embodiments. Additionally, one or more steps may be absent in some embodiments. Alternate sides of the media embellishing die 100 may be used in some steps in various embodiments.

Embellishing media and planar media 210 with embossing, piercing, cutting, and the like, as described and shown herein may be performed in a multitude of different ways and with various configurations of media embellishing dies 100. An artistic and free modification of the techniques, systems, tools and methods described and shown herein is contemplated and within the scope of various embodiments.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

1. A method of embellishing media comprising:
providing a substantially planar media embellishing die comprising:
a first embellishing side comprising an embellishing ridge;
a second embellishing side; and
a plurality of embellishing holes defined by the media embellishing die;
positioning a media sheet against said first embellishing side;
compressing said media sheet against said media embellishing die such that said embellishing ridge cuts said media sheet;
positioning said media sheet against said first embellishing side;
positioning an embossing sheet against said second embellishing side;
compressing said embossing sheet and said media sheet against said media embellishing die such that said embellishing ridge embosses said media sheet;
positioning said media sheet against one of said first and second embellishing side and
piercing said media sheet via a piercing tool using at least one of said plurality of embellishing holes as a piercing guide.

2. The method of claim 1, wherein said media embellishing die further comprises an embellishing orifice; and
wherein said compressing said embossing sheets and said media sheet against said media embellishing die further facilitates said embellishing orifice to emboss said media sheet.

3. The method of claim 1, wherein said media embellishing die further comprises an embellishing edge; and
wherein said compressing said embossing sheet and said media sheet against said media embellishing die further facilitates said embellishing edge to emboss said media sheet.

4. The method of claim 1, wherein said compressing said embossing sheets and said media sheet against said media embellishing die further facilitates said embellishing holes to emboss said media sheet.

5. A media embellishing system comprising:
a substantially planar media embellishing die comprising:
a first embellishing side comprising an embellishing ridge;
a second embellishing side; and
a plurality of embellishing holes defined by the media embellishing die.

6. The media embellishing system of claim 5, further comprising an embellishing orifice defined by the media embellishing die.

7. The media embellishing system of claim 5, further comprising a first and second embellishing edge defined by the media embellishing die.

8. The media embellishing system of claim 7, wherein said first and second embellishing edge are substantially parallel.

9. The media embellishing system of claim 7, wherein said embellishing ridge is proximate to said second embellishing edge.

10. The media embellishing system of claim 7, wherein said embellishing ridge and second embellishing edge are substantially parallel.

11. The media embellishing system of claim 5, wherein the media embellishing die is symmetrical about a central axis.

12. The media embellishing system of claim 5, wherein said first and second embellishing edge are symmetrical about a central axis.

13. The media embellishing system of claim 5, wherein the height of said embellishing ridge is approximately less than or equal to the thickness of said media embellishing die.

14. The media embellishing system of claim 5, wherein said embellishing ridge is operable to perform at least one of embossing and cutting.

15. The media embellishing system of claim 5, wherein said embellishing ridge is operable to perform both embossing and cutting.

16. The media embellishing system of claim 5 further comprising a substantially planar embellishing guide comprising at least one of a structure and a marking complementary to a structure of said media embellishing die.

17. The media embellishing system of claim 16 wherein said embellishing guide is light transmissive.

18. The media embellishing system of claim 16 wherein said embellishing guide and said embellishing die comprise a plurality of complementary embellishing holes.

19. A method of embellishing media comprising:
providing a substantially planar media embellishing die comprising:
a first embellishing side comprising an embellishing ridge;
a second embellishing side; and
a plurality of embellishing holes defined by the media embellishing die;
positioning a media sheet against said first embellishing side;
compressing said media sheet against said media embellishing die such that said embellishing ridge cuts said media sheet;
positioning said media sheet against said first embellishing side;
positioning an embossing sheet against said second embellishing side;
compressing said embossing sheet and said media sheet against said media embellishing die such that said embellishing ridge embosses said media sheet;
providing a substantially planar media embellishing guide comprising a plurality of embellishing guide embellishing holes defined by said media embellishing guide;
positioning said media sheet against said embellishing guide; and
piercing said media sheet via a piercing tool using at least one of said plurality of embellishing guide embellishing holes as a piercing guide.

20. The method of claim 19 wherein said embellishing guide is light transmissive.
